(19) United States
(12) Patent Application Publication
(10) Pub. No.: US 2024/0123396 A1
(43) Pub. Date: Apr. 18, 2024

(54) FAD DRYER REGULATING SYSTEM AND METHOD

(71) Applicant: Atlas Copco Airpower, Naamloze Vennootschap, Wilrijk (BE)

(72) Inventors: Frederico DE LACQUET ROCHA E SILVA, Wilrijk (BE); Geert HELLEMANS, Wilrijk (BE)

(21) Appl. No.: 18/465,216

(22) Filed: Sep. 12, 2023

Related U.S. Application Data
(60) Provisional application No. 63/405,663, filed on Sep. 12, 2022.

(51) Int. Cl. B01D 53/06; B01D 53/26; B01D 53/30

(52) U.S. Cl. CPC B01D 53/06; B01D 53/261; B01D 53/30; B01D 2257/80; B01D 2259/4009

(57) ABSTRACT

Methods, systems, and apparatus for setting a rotational speed of a rotor of a compressed-gas dryer system, without communication from an associated compressor (e.g., without knowing compressor speed or load). Such communication is not always practical or possible (e.g., in the case where a dryer may be provided by a different manufacturer as compared to the compressor). In such a case, the speed or load at which the dryer should run can be determined by making an FAD calculation, so as to determine the volumetric flow rate through the inlet into the drying zone of the dryer. This measurement can be made at the inlet (a venturi or other nozzle), or elsewhere in the system (e.g., other inlets or outlets). Determination of flowrate of compressed-gas to be dried can be done independent of any communication with the compressor. This can be done by measuring inlet temperature, pressure, and pressure drop.

### FIELD OF THE DISCLOSURE

The present disclosure relates to methods, systems, and apparatus for monitoring and controlling a compressed-gas dryer, and particularly for monitoring, controlling, and optimizing the efficiency of a rotary drum dryer of a compressed-gas system especially where the rotational speed of the rotor of the dryer is set without the need for any control inputs from the associated compressor (such as compressor speed or load).

### BACKGROUND

Dry compressed air is used in a wide range of applications including, but not limited to, food processing, chemical and pharmaceutical operations, pneumatic tools, HVAC and HVAC control systems, abrasive blasting, injection molding, airbrushing, and manufacturing, for example, the manufacture of electronic componentry. In the food industry, dry air is used to dehydrate grains, dairy products, vegetables and cereals. In the electronics industry, dry compressed air is used, for example, to remove demineralized water and cleaning solvents from silicon devices and circuit boards.

Atmospheric air contains water vapor, and this water vapor must be taken into consideration when producing compressed air. For example, a compressor with a working pressure of 7 bar and a capacity of 200 liters/second that compresses air at 20° C. with a relative humidity of 80% will release 10 liters/hour of water into the compressed air line.

Water and moisture in a compressed air system can cause erosion, corrosion, and biological effects which can result in product spoilage, equipment malfunction and system failure. For example, in a compressed air line, water is fluidized to an aerosol mist by the turbulent air flow and the droplets are propelled at high velocity until they impact on obstructions in their path, such as piping elbows, valve discs, orifice plates, or air motor blades. The resulting repeated impacts produce pitting. Further, the produced pits caused by the high-velocity water aerosol mist provide havens for salt ions and acids, which further corrode the surface by chemical action. The weakened surface is then prone to stress corrosion by mechanical vibration and flexing. Erosion can be controlled by eliminating liquid aerosols and particles in air and removing water vapor, which can condense and form liquid droplets, from compressed air systems. Thus, in installations where compressed air lines are exposed to low temperatures and are prone to condensation, it is important that the air be dried to a dew point below the lowest possible operating temperature.

In addition to erosion, moisture in compressed air systems can cause corrosion and destructive biological effects. Water and oil vapors can be removed by adsorption processes. Liquid aerosols may be removed from the air stream by such means as coalescing filters. Wet corrosion in compressed air systems is particularly aggressive because of the absorption of corrosive agents from the air. Although pure liquid water is not itself corrosive, very corrosive solutions are formed when water is combined with salt particles or acidic gases. It is known that corrosion can be controlled by drying the air to its lowest possible dew point.

Further, moisture in compressed air systems is harmful because moist air permits the growth of bacteria, fungus and mold, which produce acidic waste that also fosters corrosion of compressed air systems. Microorganisms may also accumulate in instrumentation tubing and air motor bearings, resulting in malfunction, excessive wear rates, and seizure. Thus, it is advantageous for controlling harmful biological effects, to dry the air to a dew point which reduces the relative humidity to below 10%.

Additionally, moisture in compressed air can cause product contamination by both direct and indirect means. Both water droplets and water vapor can be absorbed by the product in direct contact processes, such as, by way of example, in chemical mixing, and paint spraying applications. The absorption of water can adversely affect the chemical and physical properties of the product.

In applications of dry compressed air, such as in manufacturing, a −40° F. to −100° F. dew point air is often used and therefore, it is advantageous to utilize a drying process in which the air is dried to its lowest possible dew point. For example, compressed air used in analytical instrumentation must be extremely pure and contain minimal levels of water vapor. Infrared analyzers and gas chromatographs used to analyze air for environmental chamber and physiological respiration testing typically require stable quality air and dew point levels below −60° F. Such high purity air, called “zero air,” is also beneficial in prolonging the life of sensitive components, in preventing contamination of the test samples and in preventing undesirable side reactions during analysis.

The degree of dryness required is generally determined by an analysis of each individual compressed air system and the air-drying system should be designed to reduce the water vapor content to the lowest dew point level.

There are known compressed gas dryer systems, such as rotary drum dryers, which are provided with a pressure vessel containing a drying zone and a regeneration zone. Such systems also often include a cooling zone. A rotatable drum is provided in the pressure vessel with a regenerable desiccant.

The pressure vessel includes an inlet to the drying zone for the supply of compressed gas to be dried and an outlet for the discharge of dried gas. A warm regeneration gas is supplied to the regeneration zone for regeneration of the desiccant. The dryer further includes a driver that rotates the drum such that the drying agent (desiccant) is successively moved through the drying zone and the regeneration zone (and cooling zone, as applicable).

Removal of moisture from an air feed stream can be considered to depend upon several factors including the rate of flow of the gas streams, the rate of moisture adsorption and moisture content of the adsorbent, as well as the temperature and pressure of the air within the bed.

Within many compressed-gas dryer systems, the rotational speed of the rotor of the dryer system is set based on the rotational speed or load under which the compressor feeding the compressed-gas dryer system is running Where this information is not readily available, it can be difficult to efficiently operate the rotor of the dryer system at an appropriate rotational speed at all times, to provide compressed gas at the desired dew point, provide an appropriate fractionation between the compressed gas to be dried and the regeneration flow, and to maintain the desired regeneration cycling of the desiccant within the system. Such can occur in situations where the compressor is provided by one manufacturer, and the dryer by another manufacturer, such that communication between such components may not be practical.

One method for accurately predicting the contamination level of the gas stream exiting the adsorption sector and optimizing the performance and fractionation efficiency of the rotating drum adsorber system, is described in U.S. Pat. No. 6,527,836. Such a method, includes providing a complex proposed set of drum dryer design and operational parameters and initial operating conditions, calculating predicted dew points at such conditions, determining temperature information from the regeneration and cooling sectors, and displaying the sector temperature profiles and discharge temperatures at predicted dew points for evaluation by an engineer for providing optimum performance of the system and achieving a lowest effluent dew point. Such known methods include determining the average or mixed concentration discharging over the entire surface in the adsorption sector and the mixed stream discharge temperature exiting the cooling sector. The average or mixed discharge concentrations in the adsorption sector are determined using classical adsorption equations:

Jₒ=0.5[1-erf{(N)^{1/2}−(NT) ^{1/2}}](Nearly linear isotherm) (1)

Jₒ=0.5[1-erf{(N)^{1/2}−(NT)^{1/2}}](Nearly constant isotherm) (2)

where Jₒ=c₁/cₒ (3)

N=L/H_{d} (4)

T=(Cₒ-C₁)(μ₀τ-V∈)/(n−nᵢ)ρ_{α}LAₓ) (5)
c₁: effluent contaminant concentration
c₀: influent contaminant concentration
N: Number of mass transfer units, dimensionless
T: Material balance ratio, solute adsorbed per adsorbent capacity
L: Adsorbent bed length
H_{d}: Mass Transfer Unit Height
uₒ: Mass flow rate in adsorption sector
τ: time in adsorption sector
V: Adsorbent bed volume in adsorption sector
ε: Adsorbent bed void fraction
n: Adsorbent bed equilibrium capacity per unit weight
nᵢ: Initial concentration in adsorbent bed
ρₐ: Adsorbent bed density
Aₓ: Adsorption section cross sectional surface area

In such known methods, Equation (1) above is used with adsorbents characterized by nearly linear isotherms, such as, by way of provided example, silica gel and activated alumina. Equation (2) above is used with adsorbents characterized by nearly constant isotherms, such as, by way of provided example, molecular sieves, or zeolites and activated titanium dioxide. In the cooling sector, Equation (1) is used to determine the temperature profile and the integration of this equation provides the mixed stream discharge temperature and the terms in Equation (1) are defined in terms of heat transfer:

Jₒ=(t−t₀) (6)

N=L/H (7)

T=cₚ(τ_{c}u_{c}−V∈)/(cₚₐρₐLAₓ) (8)
t: discharge temperature
t₀: initial bed temperature
t₁: air inlet temperature
H: Heat Transfer Unit Height
cₚ: heat capacity of gas
τ_{c}: time in cooling sector
u_{c}: mass flow rate through cooling sector
V: Adsorbent bed volume in cooling sector
cₚₐ: heat capacity of adsorbent

In these methods, the time in the cooling sector, τc, is equal to (φc/2π)/rpm where φc is the cooling sector angle in radians.

In the known methods, in the regeneration sector, prior to entering the cooling sector, two thermal fronts are considered to be established. The first thermal front approaches the equilibrium temperature where desorption occurs, and the second, lagging front approaches the elevated inlet temperature. The known methods, such as in U.S. Pat. No. 6,527,836, illustrate the two thermal fronts and the time period for which the regeneration sector is at the equilibrium temperature in a graphical display of the regeneration temperature versus the time. This graph shows a double humped temperature curve which may be used to analyze the performance of the rotating drum adsorber system. After the first hump, there is a period when the temperature in the regeneration sector remains constant showing the equilibrium temperature. According to U.S. Pat. No. 6,527,836, as long as some moisture remains in the regeneration sector, this temperature is constant. When the second hump begins, a given flute of the adsorbent drum is considered regenerated. The known methods, such as in U.S. Pat. No. 6,527,836, allow a user to adjust various inlet conditions, such as inlet temperature, system pressure, flow rate, regeneration inlet temperature, regeneration flow rate and/or rotational speed of the drum, and generate regeneration temperature versus time graphs, at various conditions, to show rotating drum adsorbent system performance changes in response to such adjustments.

In addition, using a computerized method, a user may generate various graphical displays of data such as, by way of example, Cooling Temperature vs. Time, Cooling Temperature vs. Flute Length, Dew Point vs. Inlet Temperature, Dew Point vs. Regeneration Temperature, Dew Point vs. Regeneration Flow Rate, Dew Point vs. Motor Rotational Speed and Dew Point vs. Flow Rate, for controlling the operational conditions of the rotating drum adsorber system to improve its performance and achieve lowest effluent dew point.

Further, the known methods for accurately predicting the contamination level of the gas stream exiting the adsorption sector and optimizing the performance and fractionation efficiency of the rotating drum adsorber system, such as those described by U.S. Pat. No. 6,527,836, provide a means for displaying the sector temperature profiles and discharge temperatures, as well as other system conditions, for evaluation for improving the design of the rotating drum adsorber system and achieving optimum performance In these known methods, such as those described by U.S. Pat. No. 6,527,836, the process steps and equations and calculations of a computerized method are embodied in a unique computer program to provide in-depth knowledge of the system for accurately predicting the performance and controlling the operations of a rotating drum adsorber process and system based upon a proposed set of system parameters, initial operating conditions, varied operating characteristics and performance levels of different sized rotating drums, and other variations of the system design parameters under any number of different operating conditions. The computer program is specifically designed for quickly and easily generating graphical displays, of the sector temperature profiles and discharge temperatures and other system data for evaluation to attain maximum system performance and an optimized product.

Such known systems provide for the inputting of information, including: main flow (SCFM), inlet temperature (° F.), regeneration temperature (° F.), system pressure (psig), regeneration flow (SCFM), inlet relative humidity, drive motor speed (rpm) and blower flow rate (SCFM). In addition, the computer program used in such methods provides for the selection of a rotating drum system model. The selection of the drum model number determines the diameter and length of the adsorbent drum. For example, the diameter and length of different models may be 14.5 inches and 200 mm, 14.5 inches and 400 mm, 18.5 inches and 400 mm, or 24.5 inches and 400 mm. Further, the computer program used in these methods provides for the selection of a specific manufacturer of the adsorbent drum. The preferred computer program of the known methods includes the choices of Nichias (silica gel or GX7 models) and Siebu Giken (silica gel or molecular sieve). With the selection of the model number, specific information about the physical properties of the rotating drum can be obtained, including the height and width of the flute triangle, the thickness of the media holding the silica, the approximate seal width, the angle of the adsorption sector, and the angle of the regeneration sector.

Using the input information including the initial operating conditions and drum design parameters, the computer program of the known methods, such as that described by U.S. Pat. No. 6,527,836, then calculate various information relating to product flow, the regeneration sector and the cooling sector. For product flow, the program may determine the predicted outlet pressure dew point (° F.) and outlet temperature (° F.). In the regeneration sector, the computer program may determine the equilibrium temperature (° F.), final flute outlet temperature (° F.), average outlet temperature (° F.) and flow rate (SCFM). In the cooling sector, the computer program may determine the final flute outlet temperature (° F.), average outlet temperature (° F.) and flow rate (SCFM). In addition, the computer program provides condenser inlet temperature (° F.), useful capacity [#H20/100#Dscc] and water loading [#H20]. Thus, the computer program used in these known methods provides a system information and graphical displays, as needed or desired to evaluate the performance of and/or to control the rotating drum adsorber process and system to attain maximum performance and an optimized product.

Further, graphical displays of information which may be provided by the computerized method are generated using the following main initial operating conditions and system parameters: main flow=450 SCFM; inlet temperature=100° F.; regeneration temperature=300° F.; system pressure=100 psig; regeneration flow=200 SCFM; blower head=30 WC and the rotating drum=RDD450 model. In addition, the following conditions are also included: inlet relative humidity=85%; drive motor speed=1.2 RPM; blower temperature=100° F.; and blower flow rate=225 SCFM. The initial operation conditions and system parameters provided herein are for example purposes only and may be varied, as appropriate, by the user of the computerized method.

Using this input information, the computer program of the known methods, such as that described by U.S. Pat. No. 6,527,836, calculates a pressure outlet dew point of the product flow of 1.3° F. and an outlet temperature of the product flow of 125.3° F. The computer program determines the following information relating to the regeneration sector 40: the equilibrium temperature is 156.9° F., the final flute outlet temperature is 299.2° F., the average outlet temperature is 166.7° F. and the flow rate is 200 SCFM. In the cooling sector 42, the computer program calculates the final flute outlet temperature of 127.5° F., average outlet temperature of 264.3° F. and a flow rate of 28.5 SCFM. In addition, the computer program determines that the condenser inlet temperature is 178.9° F., Useful capacity [#H20/100#Dscc] is 9.4 and the water loading [#H20] is 0.53.

While known methods, such as those described by U.S. Pat. No. 6,527,836, are described as accurately predicting the contamination level of the gas stream exiting the adsorption sector and optimizing the performance and fractionation efficiency of the rotating drum adsorber system, such methods and systems are overly complex, requiring significant computational capacity and time delay due to such computations.

Therefore, the inventor(s) of the present disclosure have identified a need for an efficient, reliable adsorption process and system for increasing the purity of an air feed stream and achieving the lowest effluent dew point, and a simpler method for designing, monitoring, and controlling such an adsorption process and system. Additionally, while reducing moisture content in a compressed-air system is required, as noted above, there is a need to do so in an simple but efficient manner, balancing the need to provide a drying process in which the air is dried to its lowest possible dew point while at the same time reducing energy consumption in the process and unnecessary wear on the air-drying system.

It has been found by the inventor(s) of the present application that a determination of what speed or load to run the dryer at can be made by using details provided only from the dryer and inputs thereto, such that no communication need be provided with the associated compressor. Such a system and method allows a dryer of one manufacturer to be paired with a compressor of another manufacturer, without the necessity of providing any communication between the dryer and the compressor, in order for the dryer to operate at a suitable speed or load, at any given time during operation.

### SUMMARY

A compressed-gas dryer system is provided that comprises a compressed gas source providing a compressed gas to be dried; a regeneration gas source providing a regeneration gas; a pressure vessel defining a drying zone and a regeneration zone, the drying zone having an inlet through which the compressed gas to be dried is received into the drying zone and an outlet through which dried compressed gas exits the drying zone, and the regeneration zone having an inlet through which the regeneration gas is received into the regeneration zone and an outlet through which the regeneration gas exits the regeneration zone; and a driver configured to drive rotation of a rotor associated with the pressure vessel in a predetermined rotational direction. The dryer system is configured to determine flow rate through the inlet of compressed gas to be dried in the drying zone. A controller is provided that sets the rotational speed of the rotor based on the determined flow rate of compressed gas to be dried.

In an embodiment, measurements may be taken at the inlet to the drying zone, to determine the needed flow rate (e.g., at a venturi or other nozzle associated with such inlet). In other embodiments, such measurements may be taken elsewhere in the system (e.g., drying zone outlet, regeneration zone inlet, regeneration zone outlet, piping between the compressor and the dryer system, or elsewhere).

In an embodiment, the compressed-gas dryer system includes a venturi or other nozzle associated with the inlet to the drying zone across which the compressed gas source to be dried passes as it enters the drying zone, and the system is configured to determine a flow rate (e.g., volumetric flow rate) across the venturi or other nozzle. While a venturi or other nozzle may be particularly well suited to determine flow rate, other types of gas flow instrumentation or measurement techniques could alternatively or additionally be used (e.g., including, but not limited to Coriolis mass flow meters, thermal flow meters, ultrasonic flow meters, rotameters, optical flow meters, etc.). Indeed, a variety of sensors and techniques may be used to determine flow rate.

In an embodiment, determination of the volumetric or other flow rate may be based on temperature and pressure measurements of the compressed-gas taken at the inlet, and pressure drop across the venturi or other nozzle. From these measurements, density of the compressed-gas at the inlet, mass flow rate across the nozzle, and volumetric flow rate across the nozzle may be determined. The system further includes a controller configured to set a rotational speed of the rotor based on the determined flow rate through the venturi or other nozzle.

A related method is disclosed, for setting rotational speed of a rotor of a compressed-gas dryer system without reference to a rotational speed or load of a compressor providing the compressed gas to be dried in the compressed-gas dryer system. The method may include providing the compressed-bas dryer system, where the system includes a compressed-gas source that provides a compressed gas to be dried; a regeneration gas source that provides a regeneration gas; and a pressure vessel defining a drying zone and a regeneration zone, the drying zone having an inlet through which the compressed gas to be dried is received into the drying zone and an outlet through which the compressed gas exits the drying zone, the regeneration zone having an inlet through which the regeneration gas is received into the regeneration zone and an outlet through which the regeneration gas exists the regeneration zone. A driver is provided, configured to drive rotation of a rotor associated with the pressure vessel in a predetermined rotational direction. The dryer system is further configured to determine flow rate of the compressed-gas through the inlet of the drying zone; and set a rotational speed of the rotor based on the determined flow rate through the inlet of the drying zone. Such rotational speed of the rotor is set without reference to any inputs or communication provided from the compressed-gas source to the compressed-gas dryer system. In an embodiment, determination of the flow rate of compressed-gas to be dried may be made by taking measurements at the inlet to the drying zone of the dryer, although it will be appreciated that in other embodiments, measurements could be taken elsewhere in the system, which measurements could then be used to determine the flow rate of compressed-gas into the drying zone. For example, measurements could be taken at the outlet of the drying zone, at the inlet of the regeneration zone, at the outlet of the regeneration zone, or even at other locations, e.g., within piping between the compressor and the dryer system.

In an embodiment, the compressed-gas dryer system includes a venturi or other nozzle associated with the inlet of the drying zone across which venturi or other nozzle the compressed gas source to be dried passes as it enters the drying zone. In an embodiment, the method includes determining a flow rate (e.g., volumetric flow rate) of the compressed gas across the venturi or other nozzle without reference to any inputs or communication provided from the compressed gas source (e.g., the compressor). The rotational speed of the rotor may then be set based on the determined flow rate of the compressed gas through the venturi or other nozzle, as determined based on these measurements.

While a venturi or other nozzle is a particularly suitable way of measuring such flow rates (e.g., by measuring temperature, pressure, and pressure drop at such venturi or other nozzle), it will be apparent that additional or alternative techniques and devices can be used to obtain the desired measurements that allow determination of the desired flow rate of compressed gas to be dried. Examples of such alternative flow meters are noted above, and could alternatively or additionally be used.

In an embodiment, a hardware storage device or a memory storage is provided

having stored thereon computer executable instructions which, when executed by one or more processors of a computing system, configure the computing system to perform a method as described.

In an embodiment, determination of the flow rate (including any intermediate determination of density, etc.) may be made through measurement of temperature and pressure at the venturi or other nozzle inlet, as well as pressure drop across the venturi or other nozzle. All necessary calculations may be based on these simple measurements.

In an embodiment, the rotational speed of the rotor is set without any Controller Area Network (CAN) or other communication provided between the dryer system and an associated compressor that generates the stream of the compressed gas fed to the compressed-gas dryer system.

In an embodiment, the rotational speed of the rotor is set to a value of from about 1 to 5 RPH (rotations-per-hour).

In an embodiment, the nozzle associated with the inlet into the drying zone includes a venturi (e.g., a venturi ejector). In an embodiment, a pitot tube, a Keil probe or other sensor may be used to measure pressure drop across such a venturi or other nozzle associated with the inlet.

In an embodiment, volumetric flow rate (e.g., in 1/s) is determined by determining (e.g., calculating) the gas density at the inlet (e.g., based on a temperature and pressure measurements at the nozzle), determining (e.g., calculating) a mass flow rate of the gas based on pressure drop across the venturi or other nozzle, and determining the volumetric flow rate therefrom.

In an embodiment, the density of the gas at the inlet is determined based on pressure and temperature of the gas at the inlet.

In an embodiment, density is determined (e.g., calculated) using the equation below

$$\\ ρ [ kg / m 3 ] = \frac{P [ bar ( a ) ] * {ρ}_{0} [ \frac{kg}{m 3} ] * 293.15}{273.15 + T [ °C ]}$$

wherein P[bar(a)] is pressure at the venturi or other nozzle inlet;

T[° C.] is the temperature at the venturi or other nozzle inlet; and ρ₀ is density of the gas at standard conditions (i.e., at 20° C. and 1 bar).

In an embodiment, mass flow rate of the gas across the venturi or other nozzle is determined using the below equation:

$$\\ {q}_{m} = \frac{C}{\sqrt{1 - {β}^{4}}} ε \frac{π}{4} {d}^{2} \sqrt{2 Δ p {ρ}_{1}}$$

wherein C is discharge factor;

wherein ε is expansibility coefficient;

wherein d is the diameter at the exit for the venturi or other nozzle;

wherein Δp is pressure drop across the venturi or other nozzle;

wherein ρ₁ i is the density of the gas at the inlet (e.g., as calculated above); and and β is the diameter ratio (Dout/Din) for the venturi or other nozzle.

In an embodiment, mass flow rate can be determined according to a simplified version of the above equation, where discharge factor (C) and expansibility coefficient (ε) are each assumed to be 1. In such a case, the simplified equation is as below:

$$QM [ kg / s ] = \frac{π * {D\_out}^{2} [ m ] * \sqrt{2 * dP [ Pa ] * {ρ}_{1} [ \frac{kg}{{m}^{3}} ]}}{\sqrt{1 - ( {β}^{4} )}}$$

wherein d_out is the diameter at the exit for the venturi or other nozzle;

wherein dP is pressure drop across the venturi or other nozzle;

wherein ρ₁ is the density of the gas at the inlet;

and β is the diameter ratio (Dout/Din) for the venturi or other nozzle;

In an embodiment, the volumetric flow rate as free air delivery (FAD) is determined using the below equation: equation:

$$QV [ l / s ] = \frac{QM [ \frac{kg}{s} ] * 1000}{{ρ}_{0} [ \frac{kg}{m 3} ]}$$

wherein QM is the mass flow rate of the gas across the venturi or other nozzle (as determined above); and

ρ₀ is density of the gas at standard conditions.

In an embodiment, the compressed-gas source is a compressor, and the regeneration gas source is a portion of a stream of a compressed gas output by the compressor.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

FIG. 1 shows a first embodiment of a compressor installation comprising a dryer system.

FIG. 2 shows another embodiment of a compressor installation comprising a dryer system.

FIG. 3 shows another embodiment of a compressor installation comprising a dryer system.

FIG. 4 shows another embodiment of a compressor installation comprising a dryer system.

FIG. 5 shows another embodiment of a compressor installation comprising a dryer system.

FIG. 6 shows another embodiment of a compressor installation comprising a dryer system.

FIGS. 7A, 7B, and 7C, show an embodiment and further details from the embodiments of FIGS. 1 to 6.

FIGS. 8A and 8B show an embodiment of a usable start and stop control device for driving the drum in the embodiment of FIGS. 1 to 6.

FIG. 9 shows a band defined by a minimum reference rotational speed and a maximum reference rotational speed according to an embodiment.

FIG. 10 schematically illustrates an existing installation including a compressor for generating compressed air and an associated dryer system, where communication is required between the dryer system and the compressor in order to determine at what speed the rotor of the dryer should run.

The drawings are included to provide a better understanding of the components and are not intended to be limiting in scope, but to provide exemplary illustrations.

### DETAILED DESCRIPTION OF VARIOUS EMBODIMENTS

The inventive concepts of the present disclosure will be described below with reference to embodiments and with reference to the drawings. But the claimed invention is not limited thereto. The drawings described are only schematic and are non-limiting in scope. In the drawings, the size of some of the elements may be exaggerated and not drawn on scale; this is for ease of illustration. The dimensions and relative dimensions do not necessarily correspond to practical embodiments of the invention.

Furthermore, the terms first, second, third and the like may be used for distinguishing between similar elements and not necessarily for describing a sequential or chronological order. The terms are interchangeable under appropriate circumstances and the embodiments of the invention can be practiced in sequences other than those described or illustrated herein.

The terms “topmost,” “upper,” “bottommost,” “lower,” “above,” “below,” and the like in the description and in the claims are also used for purposes of example and are not necessarily used to describe relative positions. These terms are interchangeable under appropriate circumstances and the embodiments of the invention described herein can be practiced in other orientations than described or illustrated herein.

In addition, the various embodiments which may be described as “preferred embodiments” are to be construed as merely illustrative of ways and modes for carrying out the invention and not as limitations on the scope of the invention.

The terms “comprising”, “including”, or “having” as used in the claims should not be interpreted as being limited to the means or steps mentioned thereafter. The terms are to be interpreted as specifying the presence of the stated features, elements, steps or components as referred to, but do not preclude the presence or addition of one or more other features, elements, steps or components, or groups thereof. Thus, the scope of the expression “an apparatus or device comprising means A and B” should not be taken as being limited to an apparatus or device consisting only of components A and B. It is intended that for the purposes of this disclosure, only the parts A and B of the device are specifically mentioned, but the claims should be further construed to include equivalents of these parts.

Generally, the compressed-gas drying systems of the present disclosure comprise a pressure vessel that includes a drying zone and a regeneration zone, and a rotational portion or rotor, such as a rotatable drum in the pressure vessel. The rotor or drum is a multi-chamber adsorbent fractionator containing an adsorbent medium, which serves as a regenerable desiccant. Additionally, a cooling zone may also be included.

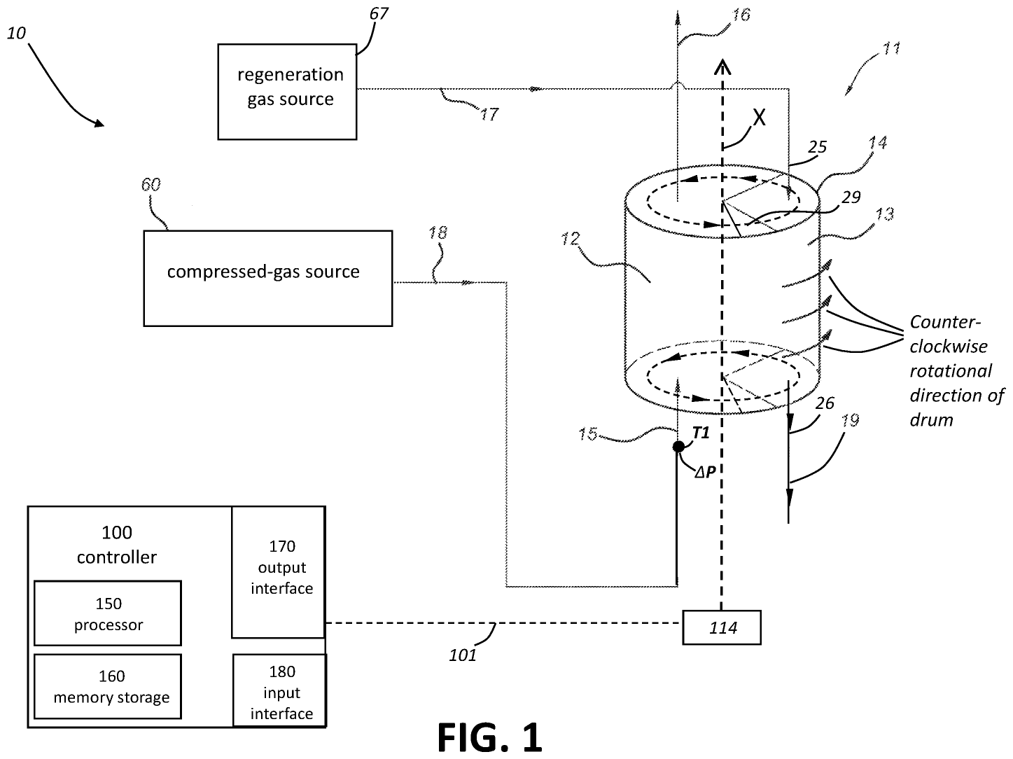

In the first embodiment of the compressed gas dryer system shown in FIG. 1, a dryer 10 for a compressed gas system is provided for a compressed-gas source 60. Compressed-gas source 60 may be, for example, a compressor. However, the dryer system including dryer 10 may be provided with other compressed-gas sources, such as a pre-compressed gas tank, reservoir, or a supply pipe or line. Further, multiple dryers 10 may be provided within a compressed-gas system or along a compressed-gas line or pipe. The dryer 10 comprises: a pressure vessel 11, the pressure vessel 11 comprising a rotational symmetry in which a drying zone 12, a regeneration zone 13, and optionally a cooling zone 29 are defined. A rotor, for example, a drum 14, is provided in the rotationally symmetrical portion and provided with a multi-chamber adsorbent fractionator containing an adsorbent medium, which serves as a regenerable desiccant. The adsorbent medium may include silica gel, activated alumina, a molecular sieve, activated titanium dioxide, or activated carbon. A driver 114 or driving means is provided for rotating the drum relative to the rotational symmetry around axis X, i.e., rotating the drum 14 in the rotational symmetry or rotating the rotational symmetry around a stationary drum, such that the desiccant moves through the drying zone and the regeneration zone in succession. The driver 114 may include an electric motor. The driver 114 shown in the figures is shown schematically. While driver 114 in FIG. 1 is provided along a rotational axis X of the drum 14, this is not necessarily the case. Driver 114 may be provided at a position offset from the rotational axis of the drum 14. The motor of driver 114 is controllable, and may be of a variable speed or may only be controllable by turning on and off. Driver 114 may further cause drum 14 to rotate by a driving means, which may include a transmission, gears, pulleys, belts, chains, and/or, a drive shaft, or other means that transfer rotation from a motor or engine to cause rotation of the drum. Further, the driver 114 may be within the pressurized volume of the dryer or may be exterior to the pressurized volume of the dryer.

Compressed gas to be dried is supplied to drying zone 12 within the pressure vessel 11 by main line 18, which supplies the compressed gas to be dried to inlet 15 of the drying zone. Compressed gas that has been dried exits the drying zone at outlet 16, which is connected to the remaining, downstream portion of the compressed gas system (not shown). Regeneration gas is provided to the regeneration zone 13 within the pressure vessel 11 by connection line 17 which provides regeneration gas or air from regeneration gas source 67 to inlet 25 of the regeneration zone 13. Regeneration air exits the regeneration zone 13 at outlet 26 to connection line 19, which may be returned to regeneration air source 67 through a supply line (not shown) or may be further used, as described in the various embodiments provided below. As described herein, regeneration gas source 67 may be provided with compressed gas from compressed gas source 60, such as by a compressor. Or alternatively, regeneration gas source 67 may be provided with a regeneration air or gas from an entirely separate source, such as from another compressor or a separate pipe, line, or compressed gas system. Cooling zone 29 may be supplied by a cooling agent by a separate cooling supply line (not shown). As shown, the flow of regeneration gas into inlet 25 and out outlet 26 may be counter-current to flow of compressed gas to be dried entering at inlet 15 and exiting at outlet 16.

In the embodiment according to FIG. 1, a temperature sensor (T1) may be provided for measuring the temperature of the compressed gas flow at the inlet 15 of the drying zone 12. Such a temperature sensor at a nozzle inlet of the dryer 10 may be used in determining density and a flow rate of compressed gas into the dryer 10, without there being any communication to the dryer from a compressor or other compressed-gas source, as described herein (e.g., no CAN cable or the like). Other temperature sensors may additionally be provided within the dryer system, e.g., at various inlets and outlets, e.g., as described in Applicant's patent application Ser. No. 63/333,284 entitled Temperature-Based Monitor and Control of a Compressed-Gas Dryer, filed Apr. 21, 2022, herein incorporated by reference in its entirety. Temperature sensor T1 (or any other temperature sensor within the dryer 10) may include one or more thermocouples, liquid or gas thermometers, electrical thermometers including, for example, an electric resistance thermometer, silicone diode, bimetallic devices, bulb and capillary sensors, sealed bellows, and/or a radiation thermometry device, or any other type of temperature sensing device. While temperature sensor T1 is shown positioned at the inlet into the drying zone, it will be appreciated that other placements are possible, where other measurements could be used to determine the flow rate of compressed gas into the drying zone.

One or more pressure sensors may also be present at the inlet, for measuring inlet pressure and pressure drop across the venturi or other nozzle as the compressed gas passes through the venturi or other nozzle. Although FIG. 1 simply designates AP at this location, it will be appreciated that two or more sensors may be present, in order to determine both the pressure at the nozzle inlet and the pressure drop across the venturi or other nozzle. Any of various pressure sensors may be employed, including, but not limited to a pitot tubes, Keil probes, or any other type of pressure sensing device. While the pressure sensor is shown positioned at the inlet into the drying zone, it will be appreciated that other placements are possible, where other measurements could be used to determine the flow rate of compressed gas into the drying zone. For example, measurements could be taken at drying zone outlet 16, regeneration zone inlet 25, regeneration zone outlet 26, within line 18 that conveys the compressed-gas, etc. It will be apparent that a variety of measurements could be taken, at varying locations, in order to determine the flow rate of compressed-gas into the drying zone to be dried, such that the particular embodiments described in conjunction with the Figures are merely exemplary. For example, a mass balance could be performed with any such measurements taken at various outlets, inlets, or other locations in the system, in order to determine the flow rate of compressed gas into the drying zone.

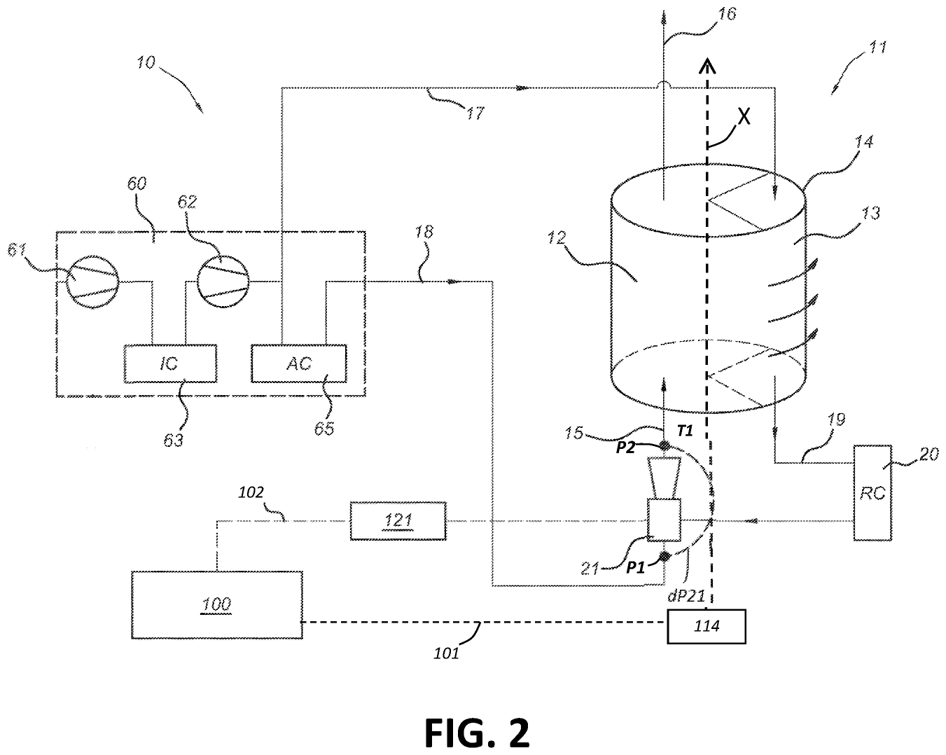

In the embodiment of FIG. 1, a control unit or controller 100 is provided. Controller 100 comprises a processor 150, for example, a microprocessor, a memory storage 160, an output interface 170, and an input interface 180. Controller 100 receives input signals through input interface 180, which may be received through wired or wireless means, and processes received sensor signals obtained from sensors within the dryer system. For example, controller 100 may receive temperature signals and pressure signals from temperature and pressure sensors T1, P1, P2 (see FIG. 2), as well as other sensors present within the dryer system. As described herein, controller 100 outputs control signals to components of the dryer system through output interface 170. As described in more detail below, based on the received sensor signals obtained from the sensors of the dryer system 10, controller 100 sends control signals to adjust operational parameters of the dryer system. For example, in a preferred embodiment, controller 100 is configured to transmit control signals 101 to driver 114 to adjust the rotational speed of the driver's rotation of the drum, or to turn the driver 114 on or off, depending on the input the driver 114 is configured to receive.

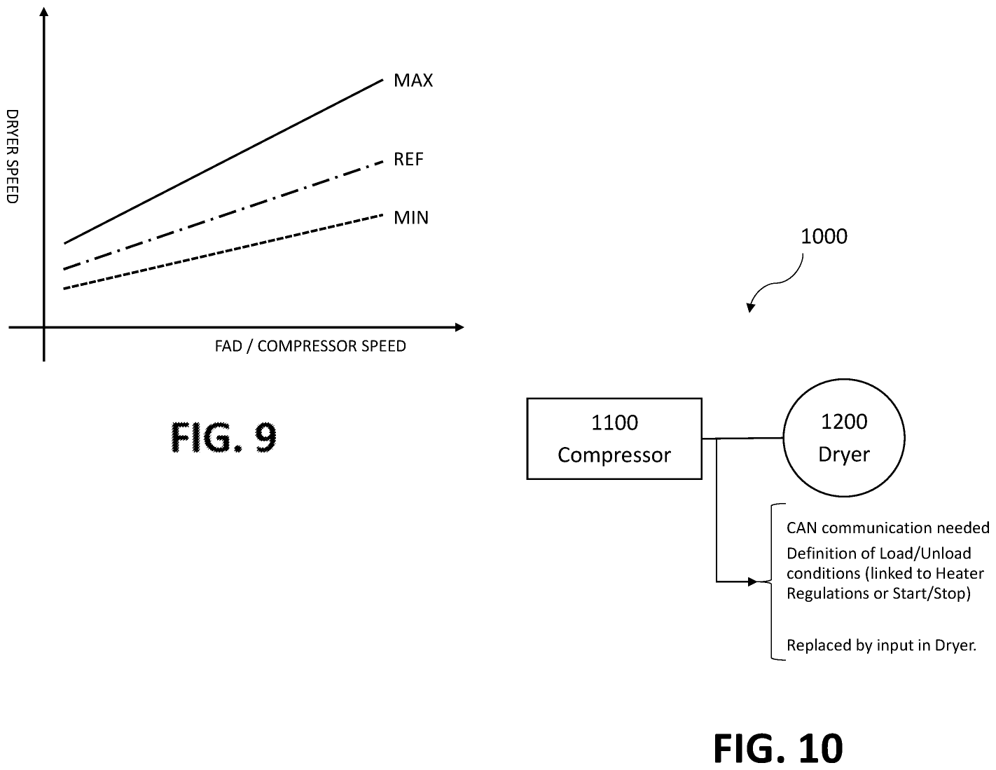

Importantly, in the present systems and methods, the control of the speed of rotation of the driver can be determined without any communication with the compressor or other compressed-gas source. For example, no CAN cable or other communication is required between the compressor or other compressed-gas source and the dryer system, in order to determine at what speed the driver should be operated at. Normally, in compressed-gas installations 1000, as shown in FIG. 10, the load or speed at which the compressor 1100 is running is communicated to the dryer system 1200, and the rotational speed of the driver of the dryer system is determined based on that input from the compressor 1100 or other compressed-gas source, in order to provide for efficient operation of the dryer 1200. In the present systems, the rotational speed or load at which the compressed-gas dryer system operates is completely independent of any communication with the compressor or other compressed-gas source. Such is particularly advantageous where the dryer is from a different manufacturer as compared to the compressor, or where communication between such components is otherwise not practical.

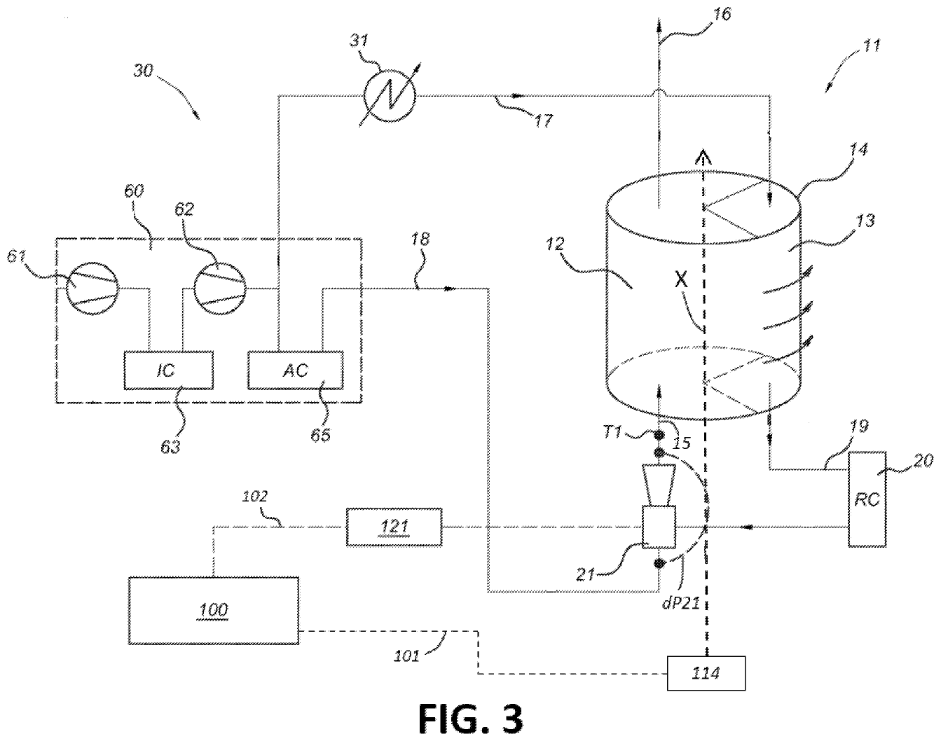

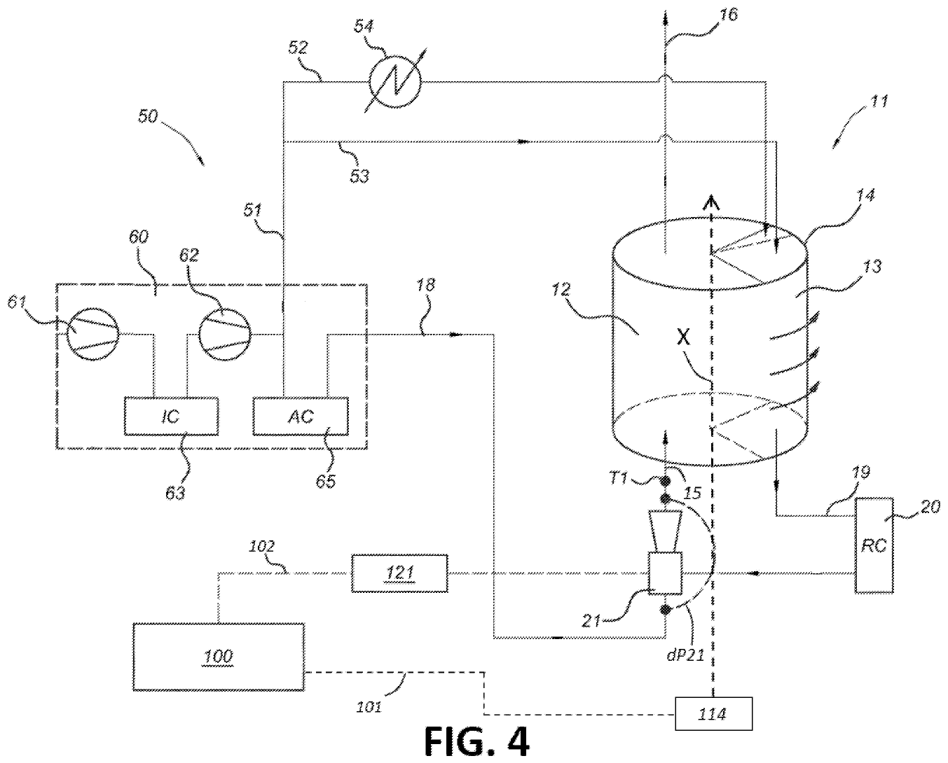

In the embodiment of the compressed gas dryer system shown in FIG. 2, a dryer 10 for compressed gas is provided to a compressed-gas source, for example, a compressor 60. Similar elements as shown in the embodiment of FIG. 1 are also included in the embodiments of FIGS. 2-4 and 5-6, bearing similar reference numbers. The compressor 60 may comprise a first compression stage 61, a second compression stage 62 and an interposed inter-cooler (IC) 63 and an after cooler (AC) 65. In the embodiment shown in FIG. 2, at the outlet side of the compressor 60, a portion of the compressed gas to be dried (having an increased temperature due to the compression) branches off and is passed (via connection line 17) to the regeneration zone for regeneration of the desiccant. In FIG. 2 this is shown as being done without further heating or cooling of the partial streams. In other embodiments, the partial flow may be first further heated by an active heating device 31 (FIG. 3), for example an electric, gas, steam or other heater. In the embodiment shown in FIG. 4, the partial flow 51 is first further divided into a first partial flow 52 and a second partial flow 53, wherein only the first partial flow 52 is further heated by the heating device 54. As shown, the first partial flow 52 and the second partial flow 53 can be introduced into different regions of the regeneration zone 13, respectively.

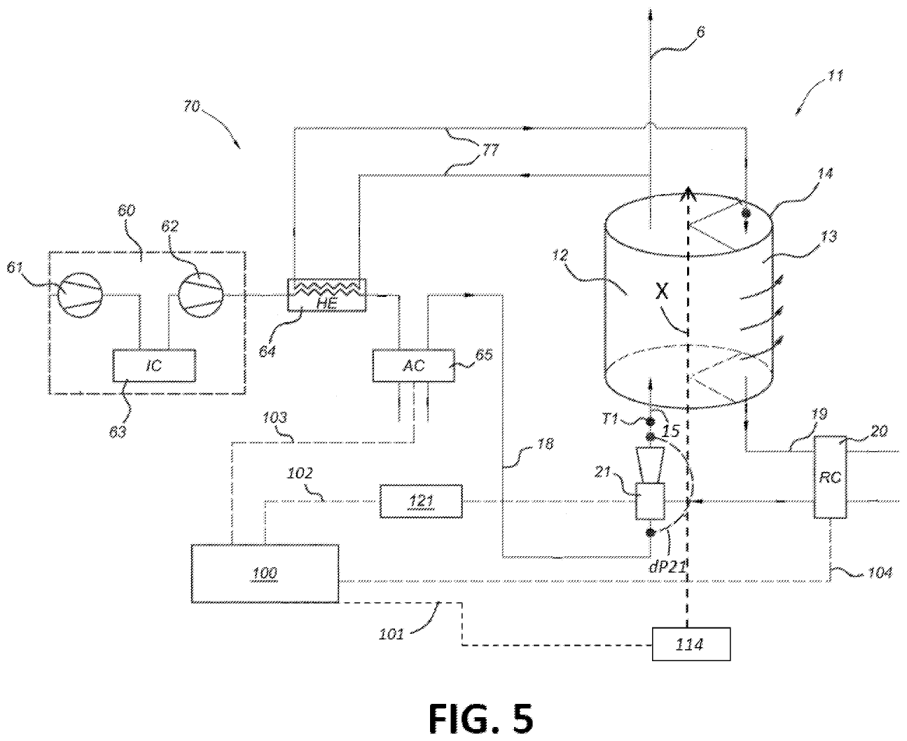

As shown in the embodiment of FIG. 5, the delivery line from the compressor 60 to the inlet 15, the compressed gas may pass through a heat exchanger (heat exchanger HE) 64 and/or a cooling device (aftercooler AC) 65.

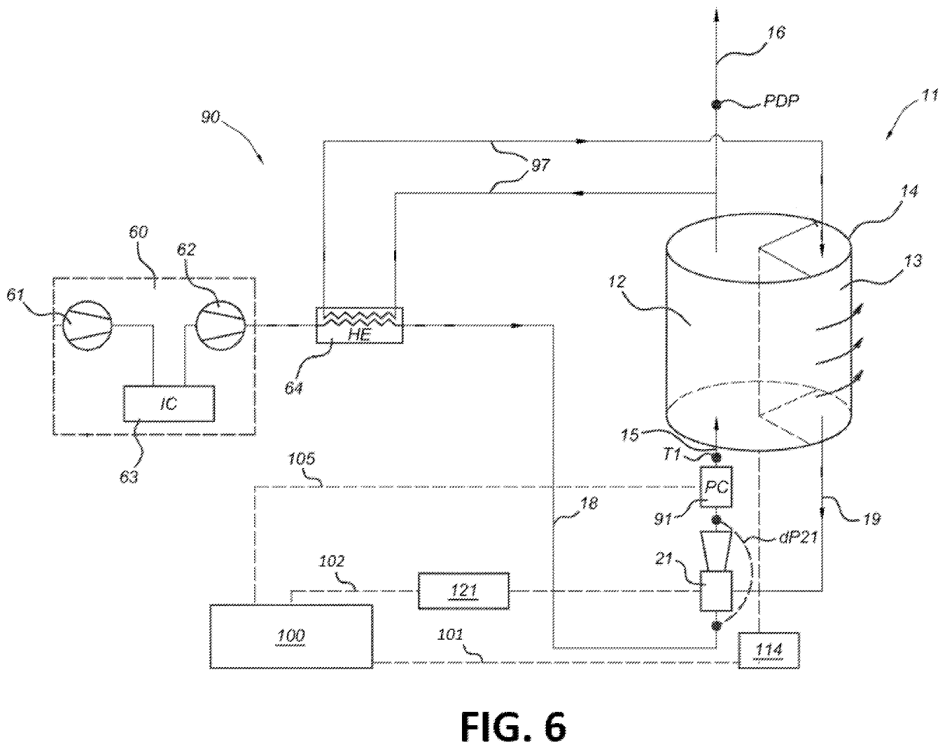

In the embodiments according to FIGS. 5 and 6, the connection lines 77, 97 respectively, are provided on the outlet side of the dryer for branching off a partial flow stream of the dried compressed gas. The partial flow stream of the dried compressed gas is directed through heat exchanger 64 to be heated with the heat present in the supply stream as a result of compression and then further directed to regeneration zone 13.

In each of the embodiments according to FIGS. 2 to 6, the partial flow for regeneration is returned via a connection line 19 to the main line 18 for the supply flow of compressed gas to be dried. This is done by a controllable device such as a venturi ejector 21 or other controllable device (e.g., another type nozzle) for creating a pressure differential. After exiting the drying zone 12, the flow can be split, for regeneration as shown. One or more cooling devices, for example, the illustrated aftercooler 65 (“aftercooler AC”) and/or the regenerative cooler 20 (“regenerative cooler RC”) and/or the process cooler 91 (“process cooler PC”), may be provided in the connection line 19 and/or the main line 18 and/or at the inlet 15 (after merging), each cooler being provided for cooling a respective gas flow by means of a coolant, for example cooling water or ice water.

Similar to the embodiment of FIG. 1, in the embodiments according to FIGS. 2 to 6, a temperature sensor T1 may be provided for measuring the temperature of the compressed gas flow at the nozzle inlet. As noted above, various other temperature and pressure sensors may be provided elsewhere within the system, as described in Applicant's patent application Ser. No. 63/333,284 entitled Temperature-Based Monitor and Control of a Compressed-Gas Dryer, filed Apr. 21, 2022, and U.S. patent application Ser. No. 18,303,939 filed at the USPTO on Apr. 20, 2023, having the same title and which claims the benefit of priority to US Provisional Application 63/333,284, both of which are herein incorporated by reference in its entirety. As described herein, by measuring or otherwise determining a temperature at the nozzle inlet, pressure at the nozzle inlet, and a pressure drop across the nozzle, the flow rate into the drying zone can be calculated or otherwise determined, from which information the rotational speed of the rotor of the dryer can be set. This advantageously can be done without any reference to the speed or load at which compressor 60 is running.

Respective output signals or data from temperature and/or pressure sensors T1, P1, and P2 can be transmitted, either through hard wiring or wireless communication, to control unit or controller 100, for use in setting the rotational speed of the rotor of dryer 10, based on the flow rate of compressed-gas into the drying zone 12. Other temperature, pressure, or other measurements may of course also be transmitted to controller 100, for use in setting rotational speed or other operational parameters of the system.

In addition to measurement of the temperature T1 at the nozzle inlet of venturi ejector 21 or other nozzle inlet into the drying zone, in the embodiments illustrated in FIGS. 1 to 6, one or more pressure sensors are provided for measuring nozzle pressure and the pressure differential across the venturi ejector or other nozzle for the compressed gas flow, allowing determination of the gas flow from these three measurements.

In the embodiments according to FIGS. 1 to 6, a control unit 100 is provided in each case. Each of the provided sensors may be provided with means for communicating with the control unit 100. The communication connection may be wireless or wired; for the sake of simplified clarity, they are not shown in FIGS. 1 to 6. Respective output signals or data from these sensors are transmitted, either through hard wiring or wireless communication, to control unit or controller 100, and may be further used by controller 100 to adjust or modify the various operation parameters of dryer 10, particularly the rotational speed of the rotor of the dryer system.

In the embodiments according to FIGS. 2 to 6, in each case at least the merging means which merges the partial flow for regeneration with the main flow of the supply gas to be dried is shown as comprising a nozzle 21. The control unit 100 may be arranged for processing at least one measurement value (e.g., T1, pressure at the nozzle and pressure drop across the nozzle, i.e., ΔP or dP21) provided by the above-mentioned sensors, for determining a control signal on the basis of the measured values, and for applying the control signal to one or more controllable devices. For example, driver 121 associated with nozzle 21 and rotor driver 114 may comprise such controllable devices. For example, nozzle 21 (e.g., a venturi ejector) may be equipped with a controllable opening controlled by driver 121. Driver 114 of course can be controlled as to the rate of rotation that it imparts to dryer drum 14, or other rotor. Examples of other controllable devices that may use measurement data to determine operational parameters may include: a blower having a control for blower speed; or a plurality of smaller venturi ejectors or other nozzles arranged in parallel with respective controls for opening or closing them respectively. This has the advantage that the controllable device can be smaller in size than a single venturi ejector, and therefore can be better integrated into the pressure vessel. Also, alternatively, the controllable device may comprise a venturi ejector with a controllable bypass around it. Other controllable devices are also possible.

In rotary drum dryers, it can be important to ensure that the drum is rotating at all times, in the correct direction, and at a speed that is matched to that of the drying load required. For example, the drum 14 in the embodiment of FIG. 1 is shown as rotating in the counter-clockwise direction, as shown with the rotational arrows. In the examples described herein, the drum or rotor is shown as being configured to rotate in the counter-clockwise direction when viewed from above. Of course the inventive concepts described herein are not so limited, and the dryer system could include a pressure vessel and internal rotor configured to rotation in the clockwise direction when viewed from above, although this may be less common in the industry.

Rotation of the drum can be monitored with sensors provided in the motor or in or on the rotary drum, or within some portion of the dryer system to directly measure a position or rotational vector of the rotary drum, a shaft of the rotary drum, or within the motor itself. For example, such rotational sensors may include a Hall effect sensor, or a set of Hall effect sensors associated with one or more magnets. Other sensors are also possible. In an embodiment, temperature-based monitoring of the rotational position, speed, and/or direction may be provided based on temperature readings within the dryer system as described in Applicant's patent application Ser. No. 63/333,284 entitled Temperature-Based Monitor and Control of a Compressed-Gas Dryer, filed Apr. 21, 2022, herein incorporated by reference in its entirety. Such a system may provide for less expensive, quick, and “bullet-proof” monitoring of such characteristics.

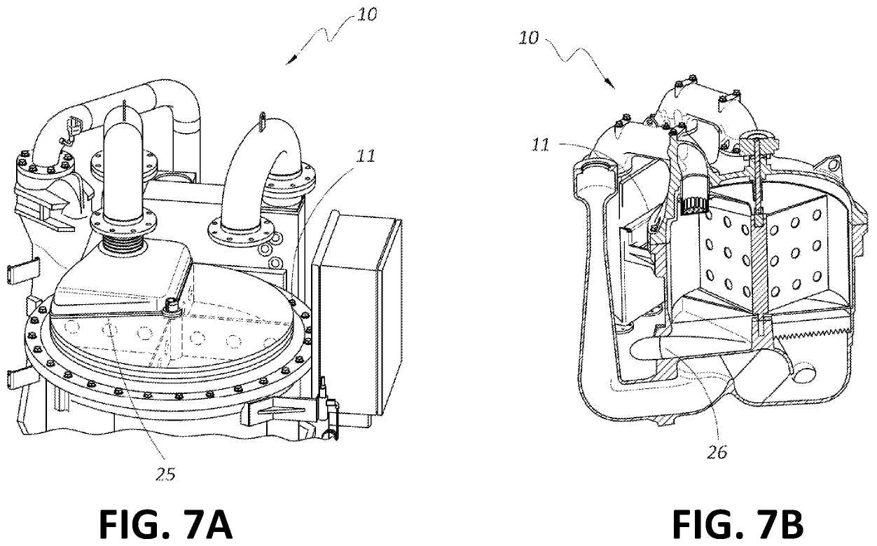

FIGS. 7A and 7B schematically show some of the internal components of an exemplary dryer 10 including a pressure vessel 11 in which a regeneration zone is provided with an inlet 25 and an outlet 26.

FIG. 7C shows a schematic top-down view of the respective zones of an exemplary dryer 10 such as that shown in FIGS. 7A and 7B, or FIGS. 1-6, each of which include a drying zone 12, regeneration zone 13, and optionally a cooling zone 29. In the embodiment of FIG. 7C, the regeneration zone 13 extends over about 90° of the circle defining the cylindrical pressure vessel or drum 14, with a starting point or origin of the circle beginning at the position labeled 0° and the regeneration zone extending to the position labeled 90°. So, in the case that the regeneration zone extends over 90° of the circle defining the cylindrical pressure vessel or drum, the regeneration zone occupies about ¼ of the volume defining the cylindrical pressure vessel or drum. Of course, the regeneration zone 13 may extend over a portion of the pressure vessel or drum that is greater than 90° or less than 90°. For example, the regeneration zone 13 may extend over any value within the range of 10° to 270° of the cross-sectional circle around an axis of the cylindrical pressure vessel or drum. In embodiment, the regeneration zone extends across 180° of a cross-sectional circle around an axis of the cylindrical pressure vessel or drum so that the regeneration zone occupies about half of the volume of the cylindrical pressure vessel or drum. Typically the regeneration zone 13 extends over 45° to 135° of a cross-sectional circle around an axis of the cylindrical pressure vessel or drum. More typically the regeneration zone 13 extends over 75° to 105° (e.g., about)90° of a cross-sectional circle around an axis of the cylindrical pressure vessel or drum.

If present, the cooling zone 29 typically extends over 5° to 45° of a cross-sectional circle around an axis of the cylindrical pressure vessel or drum. More typically the cooling zone 29 extends over 10° to 30° of a cross-sectional circle around an axis of the cylindrical pressure vessel or drum. More typically the cooling zone 29 extends over 10° to 20° of a cross-sectional circle around an axis of the cylindrical pressure vessel or drum. Typically, the cooling zone 29 extends over about 15° of a cross-sectional circle around an axis of the cylindrical pressure vessel or drum, e.g., between the portions labeled 90° and 105° , as shown in FIG. 7C.

The drying zone 12 extends about the remaining arc length of the circle not covered by regeneration zone or the combination of the regeneration zone and the cooling zone. In the example shown in FIG. 7C, the drying zone extends across the remaining 255° of a cross-sectional circle around an axis of the cylindrical pressure vessel or drum. Also, as shown in FIG. 7C, a temperature within the drying zone 12 (otherwise known as the adsorption zone (ADS)) may be on average about 60° C. The temperature within the drying zone 12 may more generally range from 20° C. to 80° C. The temperature within the cooling zone 29 may also range from 20° C. to 80° C. By comparison, a temperature within the regeneration zone (REG)) 13 may be significantly higher, e.g., up to 150° C., as the regeneration gas or regeneration air provided through inlet 25 is at a higher temperature than the compressed gas or compressed air being dried in the drying zone.

In the embodiment according to FIG. 2, a second control signal 102 may be provided to control the opening (and thus pressure drop) across venturi ejector 21. The control unit or controller 100 may be further arranged for determining the application of additional control signals 103 or 105 for aftercooler 65, process cooler 91, or the like, as shown in FIGS. 5 and 6, and described in further detail in Applicant's patent application Ser. No. 63/333,284 entitled Temperature-Based Monitor and Control of a Compressed-Gas Dryer, filed Apr. 21, 2022, herein incorporated by reference in its entirety.

In further embodiments (not shown), the control unit 100 may further be communicatively connected to a remote computer system, e.g. for remote monitoring, control, adjustment and/or software updating, etc., and data obtained by the control unit 100 and operation parameters transmitted by control unit 100 as control signals may be transmitted to the remote computer system or a data storage device for further analysis and/or processing.

In an embodiment venturi ejector 21 or other inlet nozzle may be provided with a controllable opening driven by a drive rod with a gear drive. The pressure drop caused by any particular setting for the controllable openings in the main flow 18 of gas to be dried may be measured by pressure sensors P1 and P2 communicating with the control unit 100 (to determine pressure drop dP21). Based on the nozzle inlet temperature (taken at sensor T1) and this pressure drop dP21, the control unit 100 determines a control signal 101 to be applied to the driver 114. Based on these and other inputs, additional control signals 102, 103 and 105 may also be determined and sent to appropriate devices being controlled.

The particular split associated with the regeneration connection line (17, 52, 53, 77 or 97) is at least partially determined by the position of the controllable opening in venturi ejector or other nozzle 21, as this setting determines the pressure drop, and thus the suction to which the partial flow 19 for regeneration is subjected. In this way, the flow of the split stream for regeneration may be controlled. With a relatively smaller nozzle opening, a relatively higher fraction of the flow is diverted through the regeneration loop, such that greater regeneration flow can be provided by narrowing the size of the nozzle opening.

As described above, in each of the embodiments according to FIGS. 1 to 6, the driver device 114 is provided to rotate the drum 14 relative to the rotationally symmetrical portion of the pressure vessel 11. The drive means may comprise a motor, preferably an electric motor. The electric motor may be configured to drive the rotor within the pressure vessel at a speed of more than 0 and less than 100 rotations per hour (RPH). A typical rotational speed of the rotor within the pressure vessel is less than 10 RPH. And a typical rotation speed of the rotor within the pressure vessel is around 1-5 RPH. Such values may refer to average speeds, as it will be apparent that the rotor may rotate continuously, or may rotate intermittently (i.e., stop/start). The electric motor may have a variable speed controller or may have a start/stop controller. The speed of the electric motor, or whether the electric motor is started or stopped is controlled by a first control signal 101 from the control unit 100.

A start/stop controller is arranged to switch the motor on and off, thereby providing an adjustable average rotational speed of the drum relative to the rotational symmetry. More specifically, the start/stop controller is provided for switching the motor on and off during a preferably continuous operation of the dryer, wherein on the one hand a continuous flow of compressed gas is supplied to the drying zone and dried in the drying zone, and on the other hand a continuous (partial) flow of compressed gas to be dried is led to the regeneration zone for regenerating the drying agent (desiccant). The start/stop controller is economical and may be advantageous over, for example, a frequency control for adjusting the rotational speed of the electric motor, providing capital or operational cost savings. Furthermore, a start/stop controller may be less complex and require less control electronics. In particular, the start/stop controller only needs to switch the motor on and off according to a desired duty cycle (in terms of on/off ratio) in order to provide a desired average rotational speed of the drum. In addition, the start/stop controller may rotate the drum in stages relative to the rotational symmetry, for example, to precisely move a section corresponding to the size of the regeneration zone (or a portion thereof) each time, and then stop the movement of that section for a given period of time. Another advantage of the start/stop controller is that the range of average rotational speeds is wider than when frequency control is employed; in particular, the average rotational speed may be infinitely adjusted from 0 to the maximum speed of the motor.

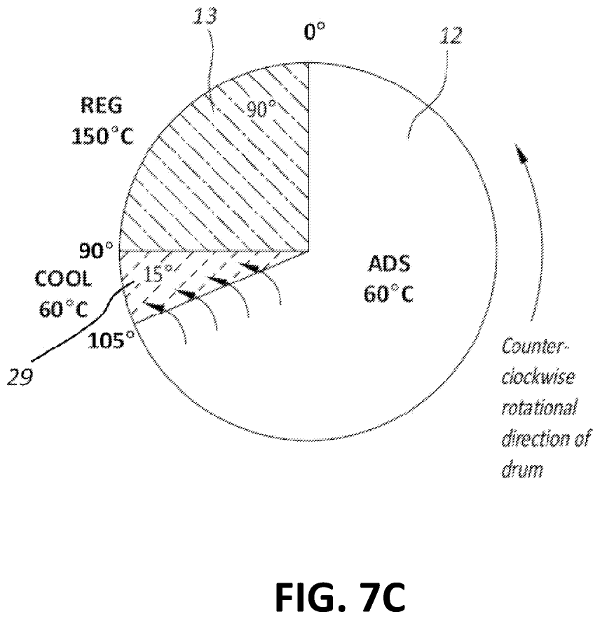

FIGS. 8A and 8B illustrate some examples of start/stop controllers. In FIG. 8A the average speed is ⅓.Vₘₐₓ. In FIG. 8B the average speed is ⅔.Vₘₐₓ. The duty cycle has a period T. The average speed can be varied by varying the time the motor is on during the period T. The average speed can also be varied by keeping the time the motor is on constant and varying the time the motor is off, which means that the length of the duty cycle T is variable.

In another embodiment, which may be included with those described above, a relatively high temperature gas, such as air with high relative humidity (e.g., saturated or nearly saturated), is supplied to the inlet 15 for the gas to be dried. Because the gas is at a relatively high temperature T1 it has a relatively high moisture content, so the drying drum 14 needs to remove more moisture from the gas, which in turn means that more regeneration is required and therefore a higher flow rate of regeneration gas is required. In addition to using measured temperature T1 to determine flow rate into inlet 15, measured temperature T1 can also be used to determine the moisture load of the gas supplied to the inlet 15. The control unit 100 may control the flow rate of the regeneration flow (split flow for regeneration) based at least in part on T1. For example, as T1 increases, the control unit may increase the flow rate, for example, according to a predetermined table or characteristic control curve. Desired normal operation of the dryer may be monitored by feedback provided by measurement of a pressure dew point sensor at outlet 16.

In another embodiment, which may be included with those described herein, if the flow rate of the regeneration flow varies (e.g. in order to keep the pressure dew point within a certain range), it may be desirable to adjust the cooling of the outgoing regeneration flow 19 and/or to adjust the rotational speed of the drum 14 dependent on the flow rate of the regeneration flow. By measuring the pressure drop across the venturi ejector 21 or other inlet nozzle, a measure of the regeneration flow rate can be obtained. The control unit 100 may, for example, control the flow rate of cooling water flowing through cooling device 20 for cooling the outgoing regeneration flow, or may control the flow rate of the cooling water flowing through cooling device 91 for cooling the confluence (supply flow of the regeneration flow and the gas to be dried) so that more cooling is performed when the regeneration flow increases, thereby avoiding a situation where too little cooling is caused by an increase in the regeneration flow rate. In conjunction or independently of this, the control unit 100 can control the rotational speed of the drum 14 according to the regeneration flow rate to optimize ratios between the two. In this way, the control unit may take into account the service life of the desiccant and may adjust the drum speed to accommodate.

T1 may be based on the mixture provided for in the embodiments of FIGS. 2 to 6, wherein a partial flow for regeneration is returned via a connection line 19 to the main line 18 for the supply flow of compressed gas to be dried. This may be done by a controllable device such as a venturi ejector 21 or other controllable nozzle device for creating a pressure differential and maintaining a split flow for regeneration.

The various illustrated configurations for dryer systems are merely exemplary. It will be appreciated that the present concepts for setting rotational speed of the dryer rotor based on a determined flow rate of gas into the dryer may be incorporated into a variety of dryer systems. Examples of additional dryer systems that may be modified to incorporate such concepts are described in U.S. Pat. Nos. 10,286,357; 10,478,771; 2,332,631; US Publication No. 2003/0163929; and CN 111821823, each of which is herein incorporated by reference in its entirety.

### Example FAD Calculations

Rotational speed, (typically measured in revolutions per hour RPH), is determinant of dryer performance and efficiency, as it determines how long the rotor is “in-duty” in the drying zone and how much regeneration time is given to the rotor. The optimal or most efficient or balanced speed provides enough time for regeneration while at the same time keeping the rotor in duty for the optimal amount of time. While the drying zone and regeneration zone are shared within the same pressure vessel and thereby have the same rotational speed, a balance must be determined or calculated to identify the most efficient or optimal rotational speed. The inventor(s) of the present disclosure have found that this rotational speed at which the rotor should rotate can be determined primarily, or even solely on a temperature reading at the nozzle inlet and a pressure drop across the venturi ejector or other nozzle. Such a control mechanism advantageously does not require any information relative to the RPM or load at which the compressor supplying the compressed-gas is operating.

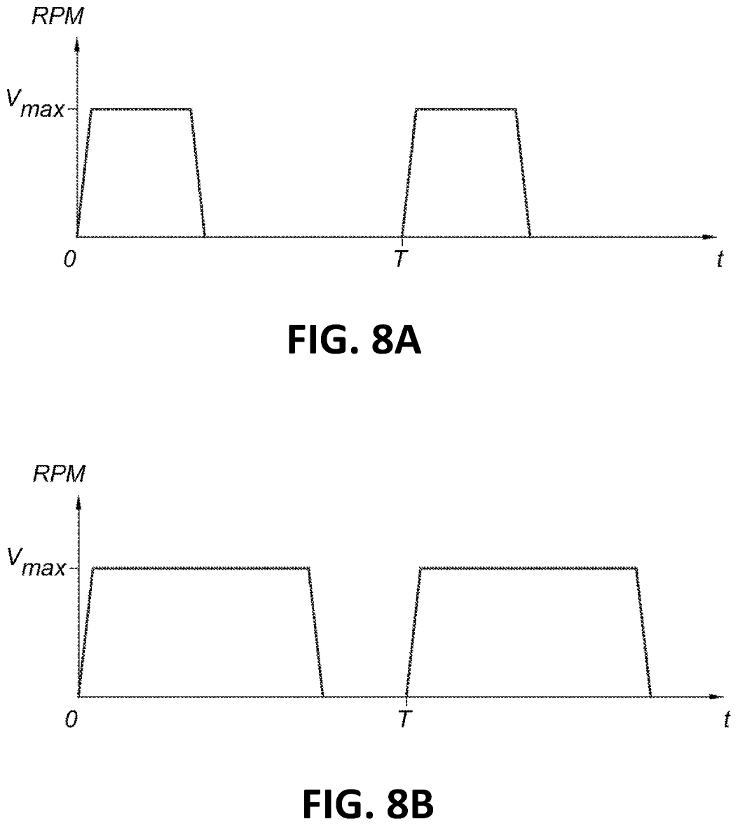

In any case, the controller controls rotation of the rotational speed of the rotor to rotate at a set speed selected between MAX speed and MIN speed. As shown in FIG. 9, the controller may default to an intermediate reference speed REF. The regulation or control of this initial reference speed can be done using calculated free air delivery (FAD), where data relative to compressor speed is unavailable, or without having to resort to the complex calculation such as in U.S. Pat. No. 6,527,836.

As an example, the FAD calculations may be obtained based on the following geometric, calculated, and measured inputs and steps.

$$Step 1 ρ [ kg / m 3 ] = \frac{P [ bar ( a ) ] * {ρ}_{0} [ \frac{kg}{m 3} ] * 293.15}{273.15 + T [ ° C . ]}$$

$$Step 2 {q}_{m} = \frac{C}{\sqrt{1 - {β}^{4}}} ε \frac{π}{4} {d}^{2} \sqrt{2 Δ p {ρ}_{1}}$$

$$Step 3 QV [ l / s ] = \frac{QM [ \frac{kg}{s} ] * 1000}{{ρ}_{0} [ \frac{kg}{m 3} ]}$$

| | Description | Symbol | Units | Formula |
|---|---|---|---|---|
| Pressure | Pressure Drop Nozzle | dP | Pa | — |
| | Ambient Pressure | P_Amb | Bar(a) | Manually Inputted |
| | Pressure at Nozzle Inlet | P | Bar(a) | P_Outlet + dP Dryer |
| Geometric | Diameter Nozzle Inlet | D_In | mm | — |
| | Diameter Nozzle Outlet | D_Out | mm | — |
| | Diameter Ratio | β | — | D_Out/D_In |
| Temperature | Temperature at Nozzle Inlet | T | ° C. | — |
| Outputs | Air Density in Nozzle | p1 | kg/m3 | — |
| | Calculated Mass Flow | QM | kg/s | — |
| | Calculated Volumetric Flow | QV | l/s | — |

As an example, the air density ρ₀ may be 1188 g/m³, the diameter of the nozzle inlet may be 128 mm, the diameter of the nozzle outlet may be 53 mm.

In step 1 the density of the air or other gas at the inlet is determined (e.g., calculated) based on the temperature as measured at the nozzle inlet (T), and the measured pressure at the nozzle inlet P[bar(a)] and standard density of the gas (ρ₀).

In step 2, from the calculated density of the air or other gas, the mass flow rate of the air or other gas is determined (e.g., calculated) based on the pi density calculated in step 1, the measured pressure drop across the nozzle (AP), and the geometric and other parameters noted in step 2. For example, C is discharge factor (often assumed to be 1), ε is expansibility coefficient (often assumed to be 1), d is the diameter at the exit for the venturi ejector 21 or other inlet nozzle, and (3 is the diameter ratio (Dout/Din) for the venturi ejector or other nozzle.

Where C and ε can each be assumed to be 1, the equation for step 2 can be simplified to:

$$QM [ kg / s ] = \frac{π * {D\_out}^{2} [ m ] * \sqrt{2 * dP [ Pa ] * {ρ}_{1} [ \frac{kg}{{m}^{3}} ]}}{\sqrt{1 - ( {β}^{4} )}}$$

wherein d_out is the diameter at the exit for the venturi or other nozzle;

wherein dP is pressure drop across the venturi or other nozzle;

wherein ρ₁ is the density of the gas at the inlet; and

β is the diameter ratio (Dout/Din) for the venturi or other nozzle.

With the mass flow rate QM determined in step 2, the volumetric flow rate, or free air delivery [FAD] can then be determined using the equation of step 3 which simply divides the mass flow rate (QM) by the standard density of the air or other gas (ρ₀), and converts to 1/s by multiplying by 1000.

Using this calculated FAD value of compressed-gas being introduced into the drying zone of the dryer, the controller 100 can determine at what speed driver 114 should rotate drum 14 of dryer system 10. Advantageously, such a calculation or determination does not require any knowledge as to what RPM or load the compressor 60 is running at. This is particularly advantageous where the dryer and compressor may be from different manufacturers, or where such communication may not otherwise be practical.

Determination of the correlation between the determined FAD value and the rotational speed of the rotor may be determined according to a predetermined table, characteristic control curve or algorithm. By way of example, FAD flow rates may typically range up to 4000 l/s (although higher values are possible). More typical values often range from 100 to 1500 l/s.

Several exemplary FAD calculations are shown below.

| | CALC 1 | | CALC 2 | | CALC 4 | | CALC 5 | | CALC 6 | |
|---|---|---|---|---|---|---|---|---|---|---|
| dP Nozzle (Pa) | 20100 | | 19703 | | 2171 | | 4357 | | 8774 | |
| T_Nozzle_In (° C.) | 81.0000 | | 97 | | 91 | | 92 | | 93 | |
| p1 (kg/m3) | 8.1620 | | 7.82 | | 7.93 | | 7.92 | | 7.90 | |
| | QM | QV | QV | QV | QM | QV | QM | QV | QM | QV |
| | 1.28272 kg/s | 1077.92 l/s | 1.24 kg/s | 1044.58 l/s | 0.42 kg/s | 349.17 l/s | 0.59 kg/s | 494.52 l/s | 0.83 kg/s | 700.82 l/s |
| REFERENCE | 1.27 kg/s | 1070.00 l/s | 1.27 kg/s | 1070.00 l/s | 0.42 kg/s | 353.00 l/s | 0.59 kg/s | 500.00 l/s | 0.84 kg/s | 706.00 l/s |
| MEASUREMENT | | | | | | | | | | |
| | ERROR | −0.7% | | 2.4% | | 1.1% | | 1.1% | | 0.7% |

| | | |
|---|---|---|
| P_Amb | Pressure Ambient [bar(a)] | 1.013 |
| P1 | Pressure Nozzle [bar(a)] | 8.30 |
| N_D | Nozzle Diameter [m] | 0.053 |
| I_D | Inlet Diameter [m] | 0.128 |
| T1 | Temperature Nozzle Inlet [° C.] | |
| T0 | 20° C. [° C.] | 20.00 |
| ε | Expansibility Coefficient | 1.00 |
| C | Discharge Factor | 1.00 |
| β | Diameter Ratio | 0.41 |

| p1 | Rho Nozzle [kg/m3] | |
|---|---|---|
| p0 | Rho at 20° C./1 bar(a) [kg/m3] | 1.19 |

As shown above, the FAD calculations are quite accurate, when compared to actual reference measurements (e.g., within 3%, within 2%, or even within 1% of actual flow rates). Such FAD calculations thus represent a simple and efficient way to determine flow rates, and from such, to determine at what speed the dryer rotor should be rotated at, to provide efficient operation of the dryer system, even where no communication may be possible or practical with the compressed-gas source (e.g., the compressor).

It is significant to note that the set speed of the dryer rotor is based solely on the temperature and pressure drop data obtained from the dryer system. The speed has not been determined by other parameters that were believed or considered in the known art, particularly compressor speed, but also humidity, ambient temperature, altitude, ambient pressure, etc. This has been found by the inventor(s) to provide a particularly robust, efficient, simple, and accurate control mechanism for efficiently controlling rotation speed of the dryer system.

While described principally in the context of measurements taken at the inlet to the drying zone of the dryer system, various temperature, pressure, or mass flow measurements could be taken elsewhere in the system (e.g., drying zone outlet, regeneration zone inlet, regeneration zone outlet, or elsewhere). From such measurements, flowrates at such locations could be determined, and using a mass balance, the flow rate into the drying zone could be determined therefrom. Such alternatives are within the contemplated scope of the present disclosure. In addition, while a venturi is present in the principally described embodiments at the inlet of the drying zone, other nozzles, flow merging devices, or mechanisms could be used to combine the various flows, and to determine flow rates at this location. Such alternatives are within the contemplated scope of the present disclosure. That is, hile a venturi or other nozzle may be particularly well suited to determine flow rate, other types of gas flow instrumentation or measurement techniques could alternatively or additionally be used (e.g., including, but not limited to Coriolis mass flow meters, thermal flow meters, ultrasonic flow meters, rotameters, optical flow meters, etc.). Indeed, a variety of sensors and techniques may be used to determine flow rate.

Embodiments of the present disclosure may comprise or utilize a special-purpose or general-purpose computer system, or a computing system, particularly in control unit or controller 100 or alternatively in communication with controller 100, that includes computer hardware, such as, for example, one or more processors 150, system memory 160, and the like. Controller 100 may be in relatively close proximity to pressure vessel 11 and driver 114, and receive hardwire or wireless signals from other components of the dryer system and send hardwire or wireless signals to other components of the dryer system. Alternatively, controller 100 may be arranged remotely from other components of the dryer system and may receive signals from other components of the dryer system, including from one more temperature or pressure sensors providing temperature or pressure data indicative of one or more temperatures or pressures within the system, and transmit signals to other components of the dryer system over a network, such as a local area network (LAN), a wide area network (WAN), the internet, or some other network.

Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be included within or accessed and executed by controller 100, a general-purpose, or a special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Certain terms are used throughout the description and claims to refer to particular methods, features, or components. As those having ordinary skill in the art will appreciate, different persons may refer to the same methods, features, or components by different names This disclosure does not intend to distinguish between methods, features, or components that differ in name but not function. The figures are not necessarily drawn to scale. Certain features and components herein may be shown in exaggerated scale or in somewhat schematic form and some details of conventional elements may not be shown or described in interest of clarity and conciseness.

Although various example embodiments have been described in detail herein, those skilled in the art will readily appreciate in view of the present disclosure that many modifications are possible in the example embodiments without materially departing from the concepts of present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scopes of the disclosure and the appended claims. Each addition, deletion, and modification to the embodiments that falls within the meaning and scope of the claims is to be embraced by the claims.

Certain embodiments and features may have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. Any numerical value is “about” or “approximately” the indicated value, and takes into account experimental error and variations that would be expected by a person having ordinary skill in the art. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

This disclosure provides various examples, embodiments, and features which, unless expressly stated or which would be mutually exclusive, should be understood to be combinable with other examples, embodiments, or features described herein.

In addition to the above, further embodiments and examples include the following:

1. A compressed-gas dryer system comprising: a compressed gas source providing a compressed gas to be dried; a regeneration gas source providing a regeneration gas; a pressure vessel defining a drying zone and a regeneration zone, the drying zone having an inlet through which the compressed gas to be dried is received into the drying zone and an outlet through which dried compressed gas exits the drying zone, and the regeneration zone having an inlet through which the regeneration gas is received into the regeneration zone and an outlet through which the regeneration gas exits the regeneration zone; a driver configured to drive rotation of a rotor associated with the pressure vessel in a predetermined rotational direction; wherein the compressed-gas dryer system is configured to determine flow rate of compressed gas to be dried; and a controller configured to set a rotational speed of the rotor based on the determined flow rate of the compressed gas to be dried.

2. The dryer system according to any one or a combination of one or more of 1 above and 3-17 below, wherein the compressed-gas dryer system includes a venturi or other nozzle, wherein determination of flow rate of the compressed gas is made using measurements taken at the venturi or other nozzle.

3. The dryer system according to any one or a combination of one or more of 1-2 above and 4-17 below, wherein the compressed-gas dryer system includes a venturi or other nozzle associated with the inlet to the drying zone across which venturi or other nozzle the compressed gas source to be dried passes as it enters the drying zone, the system being configured to determine flow rate across the venturi or other nozzle.

4. The dryer system according to any one or a combination of one or more of 1-3 above and 5-17 below, wherein the flow rate of compressed gas to be dried is measured or otherwise determined at the inlet.

5. The dryer system according to any one or a combination of one or more of 1-4 above and 6-17 below, wherein the flow rate of compressed gas to be dried is measured or otherwise determined using measurements taken at one or more of the inlet to the drying zone, the outlet of the drying zone, upstream from the inlet to the drying zone, downstream from the outlet of the drying zone, the inlet to the regeneration zone, or the outlet of the regeneration zone, or a combination thereof.

6. The dryer system according to any one or a combination of one or more of 1-5 above and 7-17 below, wherein the flow rate is determined based on temperature and pressure of the compressed-gas at the inlet and pressure drop across the venturi or other nozzle.

7. The dryer system according to any one or a combination of one or more of 1-6 above and 8-17 below, wherein the rotational speed of the rotor is set without any CAN or other communication provided from a compressor that generates a stream of the compressed gas.

8. The dryer system according to any one or a combination of one or more of 1-7

above and 9-17 below, wherein rotational speed of the rotor is set to a value from 1 to 5 RPH.

9. The dryer system according to any one or a combination of one or more of 1-8 above and 10-17 below, wherein the venturi or other nozzle associated with the inlet comprises a venturi.

10. The dryer system according to any one or a combination of one or more of 1-9 above and 11-17 below, wherein the venturi or other nozzle associated with the inlet comprises at least one of a pitot tube, Kiel probe or other sensor for measuring pressure at the venturi or other nozzle, or pressure drop across the venturi or other nozzle associated with the inlet.

11. The dryer system according to any one or a combination of one or more of 1-10 above and 12-17 below, wherein the flow rate through the venturi or other nozzle associated with the inlet is determined by determining a density of the gas at the inlet, determining a mass flow rate of the gas based on pressure drop across the venturi or other nozzle, and determining a volumetric flow rate therefrom.

12. The dryer system according to 11 above, wherein the density of the gas at the inlet is determined based on pressure and temperature at the inlet.

13. The dryer system according to 12 above, wherein the density of the gas at the inlet is determined using the below equation:

$$ρ [ kg / m 3 ] = \frac{P [ bar ( a ) ] * {ρ}_{0} [ \frac{kg}{m 3} ] * 293.15}{273.15 + T [ ° C . ]}$$

wherein P[bar(a)] is pressure at the venturi or other nozzle inlet; T[° C.] is the temperature at the venturi or other nozzle inlet; and ρ₀ is density of the gas at standard conditions.

14. The dryer system according to any one or a combination of one or more of 11-13 above, wherein the mass flow rate of the gas across the venturi or other nozzle is determined using the below equation:

$${q}_{m} = \frac{C}{\sqrt{1 - {β}^{4}}} ε \frac{π}{4} {d}^{2} \sqrt{2 Δ p {ρ}_{1}}$$

wherein C is discharge factor; wherein ε is expansibility coefficient; wherein d is the diameter at the exit for the venturi or other nozzle; wherein Δp is pressure drop across the venturi or other nozzle; wherein pi is the density of the gas at the inlet; and wherein β is the diameter ratio (Dout/Din) for the venturi or other nozzle.

15. The dryer system according to any one or a combination of one or more of 11-13 above, wherein the mass flow rate of the gas across the venturi or other nozzle is determined using the below equation:

$$QM [ kg / s ] = \frac{π * {D\_out}^{2} [ m ] * \sqrt{2 * dP [ Pa ] * {ρ}_{1} [ \frac{kg}{{m}^{3}} ]}}{\sqrt{1 - ( {β}^{4} )}}$$

wherein d_out is the diameter at the exit for the venturi or other nozzle; wherein dP is pressure drop across the venturi or other nozzle; wherein ρ₁ is the density of the gas at the inlet; and and β is the diameter ratio (Dout/Din) for the venturi or other nozzle.

16. The dryer system according to any one or a combination of one or more of 1-15 above and 17 below, wherein a volumetric flow rate [FAD] is determined using the below equation:

$$QV [ l / s ] = \frac{QM [ \frac{kg}{s} ] * 1000}{{ρ}_{0} [ \frac{kg}{m 3} ]}$$

wherein QM is the mass flow rate of the gas across the venturi or other nozzle; and ρ₀ is density of the gas at standard conditions.

17. The dryer system according to any one or a combination of one or more of 1-16 above, wherein the compressed-gas source is a compressor, and the regeneration gas source is a portion of a stream of a compressed gas output by the compressor.

18. A method for setting a rotational speed of a rotor of a compressed-gas dryer system, the method comprising: providing the compressed-gas dryer system, wherein the compressed-gas dryer system includes: a compressed-gas source that provides a compressed gas to be dried; a regeneration gas source that provides a regeneration gas; and a pressure vessel defining a drying zone and a regeneration zone, the drying zone having an inlet through which the compressed gas to be dried is received into the drying zone and an outlet through which dried compressed gas exits the drying zone, the regeneration zone having an inlet through which the regeneration gas is received into the regeneration zone and an outlet through which the regeneration gas exits the regeneration zone; and a driver configured to drive rotation of a rotor provided in the pressure vessel in a predetermined rotational direction; determining a flow rate of a compressed-gas to be dried provided to the compressed-gas dryer system; and setting a rotational speed of the rotor based on the determined flow rate of the compressed-gas to be dried.

19. The method according to any one or a combination of one or more of 18 above and 20-35 below, wherein the compressed-gas dryer system includes a venturi or other nozzle, wherein determination of flow rate of the compressed gas is made using measurements taken at the venturi or other nozzle.

20. The method according to any one or a combination of one or more of 18-19 above and 21-35 below, wherein the compressed-gas dryer system includes a venturi or other nozzle associated with the inlet of the drying zone across which venturi or other nozzle the compressed gas source to be dried passes as it enters the drying zone, the method including determining flow rate across the venturi or other nozzle.

21. The method according to any one or a combination of one or more of 18-20 above and 22-35 below, wherein the flow rate of compressed gas to be dried is measured or otherwise determined at the inlet of the drying zone.

22. The method according to any one or a combination of one or more of 18-21 above and 23-35 below, wherein the flow rate of compressed gas to be dried is measured or otherwise determined using measurements taken at one or more of the inlet to the drying zone, the outlet of the drying zone, upstream from the inlet to the drying zone, downstream from the outlet of the drying zone, the inlet to the regeneration zone, or the outlet of the regeneration zone, or a combination thereof.

23. The method according to any one or a combination of one or more of 18-22 above and 24-35 below, wherein the flow rate is determined based on temperature and pressure of the compressed-gas at the inlet of the drying zone and pressure drop across the venturi or other nozzle.

24. The method according to any one or a combination of one or more of 18-23 above and 25-35 below, wherein the compressed-gas source is a compressor, and the regeneration gas source is a portion of a stream of a compressed gas output by the compressor.

25. The method according to any one or a combination of one or more of 18-24 above and 26-35 below, or a combination thereof, wherein the rotational speed of the rotor is set without any CAN or other communication provided from a compressor that generates a stream of the compressed-gas.

26. The method according to any one or a combination of one or more of 18-25 above and 27-35 below, wherein rotational speed of the rotor is set to a value from 1 to 5 RPH.

27. The method according to any one or a combination of one or more of 18-26 above and 28-35 below, wherein the venturi or other nozzle associated with the inlet of the drying zone comprises a venturi.

28. The method according to any one or a combination of one or more of 18-27 above and 29-35 below, wherein the venturi or other nozzle associated with the inlet of the drying zone comprises at least one of a pitot tube, a Kiel probe or other sensor for measuring pressure or pressure drop across the venturi or other nozzle associated with the inlet of the drying zone.

29. The method according to any one or a combination of one or more of 18-28 above and 30-35 below, wherein the flow rate through the venturi or other nozzle associated with the inlet of the drying zone is determined by determining a density of the gas at the inlet of the drying zone, determining a mass flow rate of the gas based on pressure drop across the venturi or other nozzle, and determining a volumetric flow rate therefrom.

30. The method according to 29 above, wherein the density of the gas at the inlet

of the drying zone is determined based on pressure and temperature at the inlet.

31. The method according to 30 above, wherein the density of the gas at the inlet is determined using the below equation:

$$ρ [ kg / m 3 ] = \frac{P [ bar ( a ) ] * {ρ}_{0} [ \frac{kg}{m 3} ] * 293.15}{273.15 + T [ ° C . ]}$$

wherein P[bar(a)] is pressure at the venturi or other nozzle inlet of the drying zone; T[° C] is the temperature at the venturi or other nozzle inlet; and ρ₀ is density of the gas at standard conditions.

32. The method according to any one or a combination of one or more of 29-31 above, wherein the mass flow rate of the gas across the venturi or other nozzle is determined using the below equation:

$${q}_{m} = \frac{C}{\sqrt{1 - {β}^{4}}} ε \frac{π}{4} {d}^{2} \sqrt{2 Δ p {ρ}_{1}}$$

wherein C is discharge factor; wherein ε is expansibility coefficient; wherein d is the diameter at the exit for the venturi or other nozzle; wherein Δp is pressure drop across the venturi or other nozzle; wherein ρ₁ is the density of the gas at the inlet; and wherein β is the diameter ratio (Dout/Din) for the venturi or other nozzle.

33. The method according to any one or a combination of one or more of 29-32 above, wherein the mass flow rate of the gas across the venturi or other nozzle is determined using the below equation:

$$QM [ kg / s ] = \frac{π * {D\_out}^{2} [ m ] * \sqrt{2 * dP [ Pa ] * {ρ}_{1} [ \frac{kg}{{m}^{3}} ]}}{\sqrt{1 - ( {β}^{4} )}}$$

wherein D_out is the diameter at the exit for the venturi or other nozzle; wherein dP is pressure drop across the venturi or other nozzle; wherein pi is the density of the gas at the inlet; and β is the diameter ratio (D_out/Din) for the venturi or other nozzle.

34. The method according to any one or a combination of one or more of 29-33 above, wherein the volumetric flow rate [FAD] is determined using the below equation:

$$QV [ l / s ] = \frac{QM [ \frac{kg}{s} ] * 1000}{{ρ}_{0} [ \frac{kg}{m 3} ]}$$

wherein QM is the mass flow rate of the gas across the venturi or other nozzle; and ρ₀ is density of the gas at standard conditions.

35. The method according to any one or a combination of one or more of 18-34 above, wherein the compressed-gas source is a compressor.

36. A hardware storage device having stored thereon computer executable instructions which, when executed by one or more processors of a computing system, configure a computing system to perform the method of any one or a combination of one or more of 18-35.

37. A method for setting a rotational speed of a rotor of a compressed-gas dryer system, the method comprising: determining a flow rate of a compressed-gas to be dried provided to the compressed-gas dryer system; and setting the rotational speed of the rotor of the compressed-gas dryer system based on the determined flow rate of the compressed-gas to be dried.

38. A hardware storage device having stored thereon computer executable instructions which, when executed by one or more processors of a computing system, configure a computing system to perform the method of 37 above.

1. A compressed-gas dryer system comprising:
a compressed gas source providing a compressed gas to be dried;
a regeneration gas source providing a regeneration gas;
a pressure vessel defining a drying zone and a regeneration zone,
the drying zone having an inlet through which the compressed gas to be dried is received into the drying zone and an outlet through which dried compressed gas exits the drying zone, and
the regeneration zone having an inlet through which the regeneration gas is received into the regeneration zone and an outlet through which the regeneration gas exits the regeneration zone;
a driver configured to drive rotation of a rotor associated with the pressure vessel in a predetermined rotational direction;
wherein the compressed-gas dryer system is configured to determine flow rate of compressed gas to be dried; and
a controller configured to set a rotational speed of the rotor based on the determined flow rate of the compressed gas to be dried.

2. The dryer system according to claim 1, wherein the compressed-gas dryer system includes a venturi or other nozzle, wherein determination of flow rate of the compressed gas is made using measurements taken at the venturi or other nozzle.

3. The dryer system according to claim 1, wherein the compressed-gas dryer system includes a venturi or other nozzle associated with the inlet to the drying zone across which venturi or other nozzle the compressed gas source to be dried passes as it enters the drying zone, the system being configured to determine flow rate across the venturi or other nozzle.

4. The dryer system according to claim 1, wherein the flow rate of compressed gas to be dried is measured or otherwise determined at the inlet.

5. The dryer system according to claim 1, wherein the flow rate of compressed gas to be dried is measured or otherwise determined using measurements taken at one or more of the inlet to the drying zone, the outlet of the drying zone, upstream from the inlet to the drying zone, downstream from the outlet of the drying zone, the inlet to the regeneration zone, or the outlet of the regeneration zone, or a combination thereof.

6. The dryer system according to claim 1, wherein the rotational speed of the rotor is set without any CAN or other communication provided from a compressor that generates a stream of the compressed gas.

7. The dryer system according to claim 1, wherein the flow rate is determined based on temperature and pressure of the compressed-gas at the inlet and pressure drop across the venturi or other nozzle.

8. The dryer system according to claim 7, wherein the venturi or other nozzle associated with the inlet comprises at least one of a pitot tube, Kiel probe or other sensor for measuring pressure at the venturi or other nozzle, or pressure drop across the venturi or other nozzle associated with the inlet.

9. The dryer system according to claim 1, wherein the flow rate through the venturi or other nozzle associated with the inlet is determined by determining a density of the gas at the inlet, determining a mass flow rate of the gas based on pressure drop across the venturi or other nozzle, and determining a volumetric flow rate therefrom.

10. The dryer system according to claim 9, wherein the density of the gas at the inlet is determined based on pressure and temperature at the inlet.

11. The dryer system according to claim 10, wherein the density of the gas at the inlet is determined using the below equation:
$$ρ [ kg / m 3 ] = \frac{P [ bar ( a ) ] * {ρ}_{0} [ \frac{kg}{m 3} ] * 293.15}{273.15 + T [ ° C . ]}$$
wherein P[bar(a)] is pressure at the venturi or other nozzle inlet;
T[°C] is the temperature at the venturi or other nozzle inlet; and
ρ₀ is density of the gas at standard conditions.

12. The dryer system according to claim 9, wherein the mass flow rate of the gas across the venturi or other nozzle is determined using the below equation:
$${q}_{m} = \frac{C}{\sqrt{1 - {β}^{4}}} ε \frac{π}{4} {d}^{2} \sqrt{2 Δ p {ρ}_{1}}$$
wherein C is discharge factor;
wherein ε is expansibility coefficient;
wherein d is the diameter at the exit for the venturi or other nozzle;
wherein Δp is pressure drop across the venturi or other nozzle;
wherein ρ₁ is the density of the gas at the inlet; and
wherein β is the diameter ratio (Dout/Din) for the venturi or other nozzle.

13. The dryer system according to claim 9, wherein the mass flow rate of the gas across the venturi or other nozzle is determined using the below equation:
$$QM [ kg / s ] = \frac{π * {D\_out}^{2} [ m ] * \sqrt{2 * dP [ Pa ] * {ρ}_{1} [ \frac{kg}{{m}^{3}} ]}}{\sqrt{1 - ( {β}^{4} )}}$$
wherein d_out is the diameter at the exit for the venturi or other nozzle;
wherein dP is pressure drop across the venturi or other nozzle;
wherein ρ₁ is the density of the gas at the inlet; and
and β is the diameter ratio (Dout/Din) for the venturi or other nozzle.

14. The dryer system according to claim 9, wherein a volumetric flow rate [FAD] is determined using the below equation:
$$QV [ l / s ] = \frac{QM [ \frac{kg}{s} ] * 1000}{{ρ}_{0} [ \frac{kg}{m 3} ]}$$
wherein QM is the mass flow rate of the gas across the venturi or other nozzle; and
ρ₀ is density of the gas at standard conditions.

15. The dryer system according to claim 1, wherein the compressed-gas source is a compressor, and the regeneration gas source is a portion of a stream of a compressed gas output by the compressor.

16. A method for setting a rotational speed of a rotor of a compressed-gas dryer system, the method comprising:
providing the compressed-gas dryer system, wherein the compressed-gas dryer system includes:
a compressed-gas source that provides a compressed gas to be dried;
a regeneration gas source that provides a regeneration gas; and
a pressure vessel defining a drying zone and a regeneration zone, the drying zone having an inlet through which the compressed gas to be dried is received into the drying zone and an outlet through which dried compressed gas exits the drying zone, the regeneration zone having an inlet through which the regeneration gas is received into the regeneration zone and an outlet through which the regeneration gas exits the regeneration zone; and
a driver configured to drive rotation of a rotor provided in the pressure vessel in a predetermined rotational direction;
determining a flow rate of a compressed-gas to be dried provided to the compressed-gas dryer system; and
setting a rotational speed of the rotor based on the determined flow rate of the compressed-gas to be dried.

17. The method according to claim 16, wherein the compressed-gas dryer system includes a venturi or other nozzle, wherein determination of flow rate of the compressed gas is made using measurements taken at the venturi or other nozzle.

18. The method according to claim 16, wherein the compressed-gas dryer system includes a venturi or other nozzle associated with the inlet of the drying zone across which venturi or other nozzle the compressed gas source to be dried passes as it enters the drying zone, the method including determining flow rate across the venturi or other nozzle.

19. A hardware storage device having stored thereon computer executable instructions which, when executed by one or more processors of a computing system, configure a computing system to perform the method of claim 16.

20. A method for setting a rotational speed of a rotor of a compressed-gas dryer system, the method comprising:
determining a flow rate of a compressed-gas to be dried provided to the compressed-gas dryer system; and
setting the rotational speed of the rotor of the compressed-gas dryer system based on the determined flow rate of the compressed-gas to be dried.
